(19) United States
(12) Patent Application Publication
(10) Pub. No.: US 2007/0229377 A1
(43) Pub. Date: Oct. 4, 2007

(54) LOW PROFILE MSAT SKEWED BEAM ANTENNA METHODS AND SYSTEMS

(76) Inventors: Charles D. McCarrick, Plymouth, MA (US); Gregory Poe, Chepachet, RI (US)

Correspondence Address: STRATEGIC PATENTS P.C.., C/O PORTFOLIOIP, P.O. BOX 52050, MINNEAPOLIS, MN, 55402, US

(21) Appl. No.: 11/562,388

(22) Filed: Nov. 21, 2006

Related U.S. Application Data
(60) Provisional application No. 60/739,736, filed on Nov. 25, 2005.

(51) Int. Cl. H01Q 3/02; H01Q 19/10

(52) U.S. Cl. 343/757; 343/834

(57) ABSTRACT

An aspect of the present invention relates to the manufacture and use of co-planner parasitic patch antennas. In embodiments, methods and systems involve providing an antenna, the antenna including a first substrate, a dielectric material, and a second substrate; positioning the first and the second substrate to be co-planar; providing the first substrate with at least one parasitic patch, the parasitic patch providing gain modification; providing the second substrate with at least one parasitic patch, the parasitic patch providing gain modification; and orienting the co-planar parasitic patches of the first substrate and the second substrate for a substantially directional gain pattern.

### CROSS-REFERENCE TO RELATED APPLICATION

This application claims the benefit of U.S. Prov. App. No. 60/739,736, filed Nov. 25, 2005 and entitled “LOW PROFILE MSAT SKEWED BEAM ANTENNA METHODS AND SYSTEMS,” the entire disclosure of which is incorporated herein by reference.

### BACKGROUND

1. Field

This invention relates to methods and systems for making and using co-planar parasitic patch antennas and more generally to the field of providing satellite communication for support of public safety, emergency response teams, homeland security, and other special agencies.

2. Description of the Related Art

Several years ago companies produced and manufactured mobile tracking terminals. At the time, concerns about terrorism and disasters were not on the forefront of the nation's mind, and the demand for these systems was not high enough for companies to continue to manufacture them.

Since Sep. 11, 2001 and the hurricanes of 2005, there has been an increased demand for reliable two-way voice communication systems to support public safety, emergency response teams, homeland security, and other special agencies in the event of standard communication system shutdown.

Mobile satellite communication antenna systems are generally large and bulky when mounted on a mobile platform. Accordingly, a need exist for improved satellite communication systems including reduced scale antennas.

### SUMMARY

An aspect of the present invention relates to high-performance low-profile satellite communication devices capable of transmitting and receiving audio, video, television, data, telephone, or other such communications.

A method and system disclosed herein includes providing an antenna, the antenna including a first substrate, a dielectric material, and a second substrate; positioning the first and the second substrate to be co-planar; providing the first substrate with at least one parasitic patch, the parasitic patch providing gain modification; providing the second substrate with at least one parasitic patch, the parasitic patch providing gain modification; and orientating the co-planar parasitic patches of the first substrate and the second substrate for a substantially directional gain pattern.

A method and system disclosed herein includes orientating the antenna on a single axis to maintain optimal communication with a satellite, the single axis may be a vertical axis horizontal axis, or off-plane axis. The antenna may be rotated about the axis by a stepper motor, servo, electric motor, motor with positioning feedback, or other such device. The motor positioning may be controlled by a microprocessor, or other computer controller facility. A gyroscope may be used in conjunction with the motor and may detect the motor's motion for orientation.

In embodiments, the first substrate may be a metal. The substrate may be selected from a group of Ag, Au, Cu, Ni, and Al, or other appropriate metal. The antenna may have a dielectric layer. The dielectric layer may be selected from a group consisting of Teflon, PTFE (polytetrafluoroethylene), glass, ceramic, aluminum, polymers, silica, radiated polyolefin, and quartz, or other appropriate dielectric material. The second substrate may be a radiating layer. The second substrate may be metal or other material with radiation properties that are acceptable. The substrate may be selected from a group of Ag, Au, Cu, Ni, and Al, or be another appropriate metal.

In embodiments, the parasitic patch may be a thin metal patch attached to at least one of the substrates for the modification of the antenna gain pattern. The parasitic patch may be a driver, a director, or a reflector that may be used to modify the antenna gain pattern. A driver, director, or reflector parasitic patch may be used to lower or modify the antenna gain to a certain elevation for communications with a satellite. The drivers, directors, or reflectors may be used individually or in combination to modify the gain pattern or lower the gain pattern elevation. The drivers, directors, or reflectors may be attached to either or both substrates to modify the antenna gain pattern. In embodiments, the parasitic patch may be a circle, a truncated circle having four segments, or other appropriate shape. Two opposite segments of the parasitic patch may be parallel line segments. Two opposite segments of the parasitic patch may be segments of a circle. The orientation of the parasitic patches may be modified to alter the resulting gain pattern.

In embodiments, the antenna may be for a mobile platform, such as for mounting on a vehicle. The mobile platform may have a direction of travel and the direction of travel may vary. The mobile platform may also be stationary or stationary for period of time. The antenna may be moved to track a signal, optimize a signal or otherwise track the signal. The signal may be from a satellite, for example. In embodiments, the movement of the antenna may be a rotary motion. The rotary motion may be on a vertical axis, horizontal axis, off-angle axis or the like.

In embodiments, the antenna may track a signal during mobile platform movement. The antenna may rotate to maintain the gain, optimize gain or otherwise optimize or regulate performance, in order to maintain satellite communication. In embodiments, the antenna may automatically orientate for optimum gain. The antenna may also or alternatively be orientated manually in an embodiment.

In embodiments, the antenna may maintain position during signal obstruction. The signal obstruction may be a building, mountain, tunnel, or other object that interferes with a satellite signal. The signal may be reacquired after the signal obstruction is cleared. After the obstruction is cleared, the antenna may be rotated to re-optimize the performance.

In embodiments, the antenna may be for satellite communication for audio communication, television communication, data communication, telephone communication, email, messaging, still images (the images may be compressed or uncompressed), motion images (the images may be compressed or uncompressed), or other such communications. In embodiments, a plurality of communications may be held at the same time. In embodiments, a single line of communication may be held. In embodiments, the communication may be a secure communication. In embodiments, a broadcast communication may be involved.

In embodiments, the antenna may be adapted to transmit within one frequency band while receiving in another. For example, the antenna may be for transmission between the frequencies 1626 and 1660.5 MHz. The antenna may be for receiving between the frequencies 1525 and 1559 MHz.

In embodiments, the antenna may be used with an existing receiver. In embodiments, an interface device of the existing receiver may be used. In embodiments, a specialized interface may be used in the adaptation of the antenna to the existing receiver.

A method and system disclosed herein includes providing an antenna, the antenna having co-planar substrates with at least one parasitic patch; accessing the antenna with a cable from under the antenna substrates; and coupling the cable to the antenna to allow at least one freedom of motion axis for the antenna.

In embodiments, the antenna may have a low profile. The antenna may be mounted horizontally. The antenna cable may access the antenna from below a first substrate. The antenna may maintain a freedom of motion axis. The freedom of motion axis may be a vertical axis.

In embodiments, a coupling may connect the antenna cable to the antenna. The coupling may be a rotary coupling. The rotary coupling may use slip rings, brushes, optical, or induction for the data transmission.

In embodiments, the combination of an antenna and a rotary coupling may create a low profile assembly. The antenna may be mounted horizontally. The rotary coupling may rotate the antenna on a vertical axis.

### BRIEF DESCRIPTION OF THE FIGURES

The invention may be understood by reference to the following figures:

FIG. 1 shows an embodiment of the construction of a co-planar parasitic patch antenna.

FIG. 2 shows an embodiment of a first and second substrate with parasitic patches.

FIG. 3 shows an embodiment of a high-level circuit diagram for signal receipt and transmission.

FIG. 4 shows an embodiment of the tracking of the antenna to a satellite signal.

FIG. 5 shows an embodiment of the modular patch antenna with an axis of rotation.

FIG. 6 shows an embodiment of the cable access from under the antenna to the rotary coupling.

FIG. 7 shows an embodiment of the antenna assembly mechanical components with the radome removed.

FIG. 8 shows an embodiment of the antenna assembly mechanical components with the radome and patch antenna removed.

### DETAILED DESCRIPTION OF THE FIGURES

Various embodiments of the invention are presented as examples only and are not intended to limit or restrict the scope of the invention.

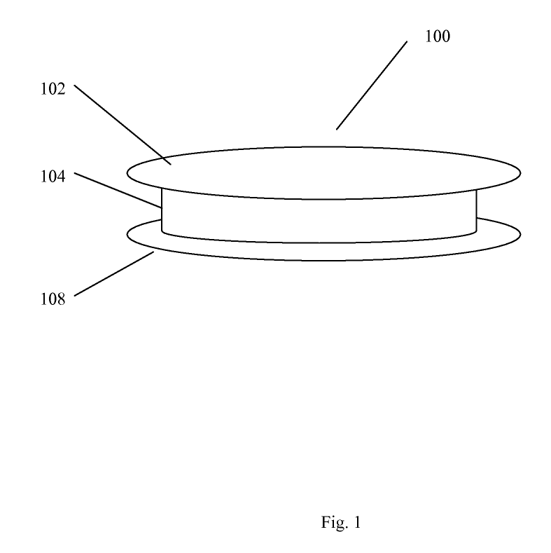

Referring to FIG. 1, an embodiment of a co-planar parasitic patch antenna 100 is shown. A co-planar parasitic patch antenna 100 may include two substrate layers and a dielectric layer between the substrate layers. The substrate layers may have parasitic patches that may modify the gain pattern of the antenna and may make the gain pattern substantially directional. The co-planar parasitic patch antenna 100 may be made up of a radiating layer 102, a middle dielectric layer 104, and a substrate layer 108.

The radiating layer 102 may be a metal plate that may be selected from a group of materials such as Ag, Au, Cu, Ni, and Al.

The co-planar parasitic patch antenna 100 may have a dielectric layer 104 between the substrates that may be selected from a group of materials consisting of Teflon, PTFE (polytetrafluoroethylene), glass, ceramic, aluminum, polymers, silica, radiated polyolefin, and quartz. The thickness of the dielectric layer 104 may be determined by the selection of the dielectric material. A person knowledgeable in the art will understand from the present invention disclosure that the antenna characteristics may be determined or altered by the selected dielectric material and the spacing between the substrates.

The substrate layer 108 may be a metal plate that may be selected from a group of materials such as Ag, Au, Cu, Ni, or Al.

In embodiments, the co-planar parasitic patch antenna 100 may take many different shapes. For example, the patch may be square, rectangular, round, circular, elliptical, a truncated circle, or other appropriate shape.

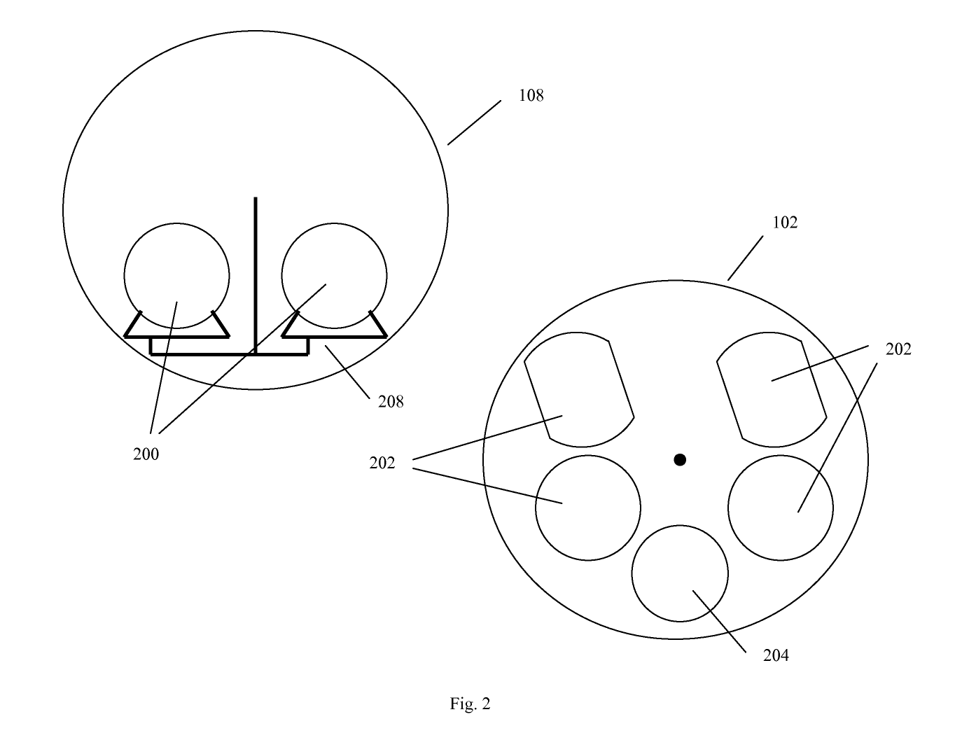

Referring to FIG. 2, an embodiment of a first substrate 108 and a second substrate 102 is shown. The substrates 108 and 102 may have parasitic patches that may be used to modify the co-planar parasitic patch antenna 100 gain pattern. A combination of parasitic patches may be used to narrow the gain pattern and provide a low elevation angle gain pattern. The gain pattern may be modified by the parasitic patches to provide an optimized gain pattern for communication with a satellite at a certain elevation from the horizon.

In an embodiment, a first substrate 108 may have a parasitic patch 200 for the modification of the co-planar parasitic patch antenna 100 gain pattern. On the first substrate 108 the parasitic patch may be a driver 200. There may be at least one parasitic patch driver 200 on a substrate. The driver 200 may be used to modify the gain pattern for a low elevation angle. In an embodiment, the number and placement of the parasitic patch drivers 200 may be varied to provide an optimized low elevation gain pattern. The drivers 200 may be connected to the circuit 208 carrying the signal for the communication.

In an embodiment, a second substrate 102 may have a parasitic patch 202 and 204 for the modification of the co-planar parasitic patch antenna 100 gain pattern. On the second substrate 102, the parasitic patch may be a reflector 204 or director 202.

In an embodiment, the reflector 204 may be used to modify the gain pattern for low elevation. In an embodiment, there may be a reflector parasitic patch 204 on a substrate. The reflector 204 may be used in combination with the driver 200 on the first substrate 108 to modify the gain pattern for a low elevation. The orientation of the driver 200 on the first substrate 108 and the reflector 204 on the second substrate 102 may influence the modification of the gain pattern to attain the proper low elevation angle gain pattern. The driver 200 and the reflector 204 may be used in combination to modify the gain pattern for a low elevation pattern.

In an embodiment, the second substrate 102 may have a director parasitic patch 202. The number, placement, and shape of the director parasitic patch 202 may be varied. There may be one or more directors 202 used on a substrate. The director parasitic patch 202 may be used to narrow the gain pattern to provide an optimized gain pattern for satellite communication. The directors 202 may be round, truncated circles, square, rectangular, or other shape to provide the desired gain modification.

In an embodiment, directors 202 may be used in sets. In embodiments, there may be two or more directors 202 used in combination for the modification of the gain pattern. In an embodiment, there may be more than one director 202 set on a substrate. The combination of the directors 202 in a set may have different shapes. In an embodiment, a first director 202 may be of one shape and a second director 202 may be of a second shape. For example, a first director 202 may be a circle and a second director 202 may be a truncated circle. In an embodiment the director sets may be of the same shape.

In an embodiment, the orientation of the first and second substrates 102 and 108 may provide for an optimized gain pattern for communication to a satellite. The parasitic patches may be orientated on the first substrate in a certain way. The parasitic patches may be orientated on the second substrate in a certain way. For examples, in an embodiment, the parasitic patches may be incorporated on the substrates as shown in FIG. 2. The first substrate 108 may have two drivers 200 that may modify the gain pattern by lowing the elevation of the gain pattern. The second substrate 102 may contain a combination of drivers 202 and a reflector 204 that may be combined to further lower the gain pattern. This combination of driver 202 and reflector 204 may also provide a modification of the gain pattern by narrowing the gain pattern to provide the proper communication to the satellite. A person knowledgeable in the art will understand that the number and location of the drivers and reflectors on either of the substrates may be varied to attain the desired shaped gain pattern and elevation. The number and location of the parasitic patches may be varied without departing from the present invention. The modified gain pattern may be a result of the combined parasitic patches 200, 202, and 204 on the substrates 102, and 108 in a certain orientation.

By placing the dielectric material 104 beneath the parasitic substrate 102 and using a dielectric material 104 with a high dielectric constant, the gain pattern may be substantially lowered in elevation. The substantially lower elevation gain pattern may allow for the use of the co-planar parasitic patch antenna 100 at higher latitudes. The higher operating latitudes may open up other markets, such as Canada and Alaska markets. The material type and thickness of the dielectric material 104 may both be adjusted to lower the gain pattern to the desired elevation.

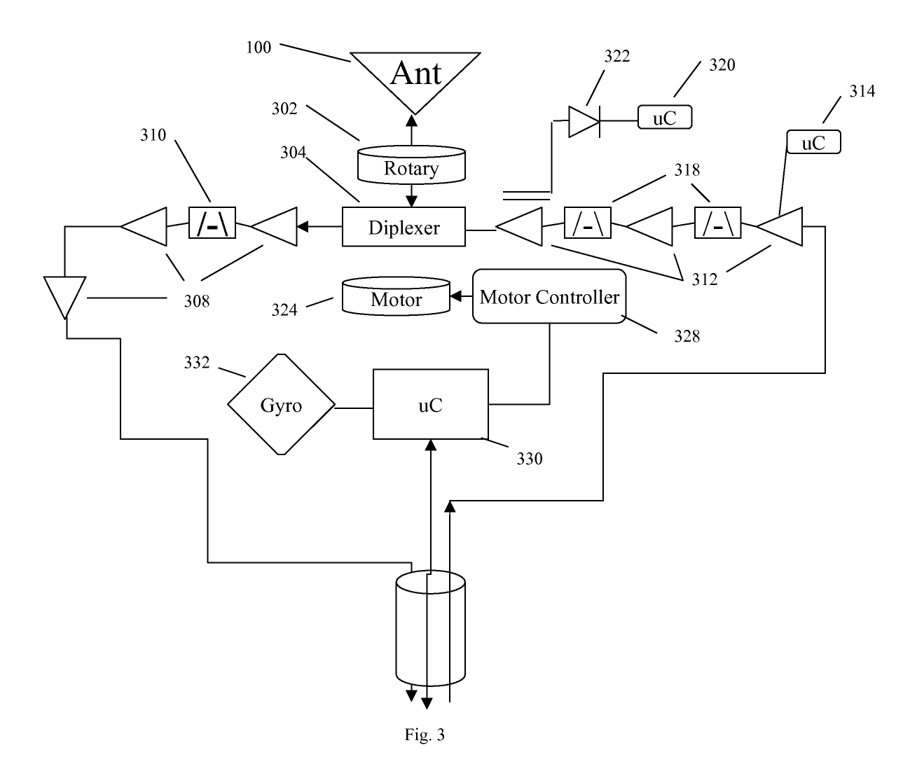

Referring to FIG. 3, an embodiment of a high level circuit diagram for the flow of data to and from the co-planar parasitic patch antenna 100 is shown. The signal strength as received from the satellite may need to be modified for communication with a receiver.

A rotary coupler 302 may be used to maintain data flow between the antenna 100 and the circuit as the antenna is rotated to maintain communication with a satellite. The rotary coupler 302 may use slip rings, brushes, optical transmission, induction transmission, or other such facilities for data transmission. The rotary coupler 302 may be driven by a motor 324, motor controller 328, microprocessor 330, and gyro 332 to maintain the correct orientation of the antenna 100 to the satellite. The microprocessor 330 may determine the correct rotation angle orientation and may provide input to the motor controller 328 to rotate the motor 324 and rotary coupler 302.

A diplexer 304 may manage the flow of data to and from the antenna 100 and the receiver.

A received signal from the antenna 100 may be weak and may require amplification and filtering for communication with a receiver. In an embodiment, there may be an amplifier 308 and a filter 310 to amplify the incoming signal. During the amplification of the signal, a filter 310 may be required to filter unwanted noise from the amplified signal. In an embodiment, amplifiers 308 and filters 310 may be used in combination to provide the desired signal strength and clarity. For example, amplifiers 308 and filters 310 may be alternated to step up the signal to the desired strength. In an embodiment, there may be a series of amplifiers 308 followed by a filter 310.

A transmitted signal from a receiver may need increased signal strength for communication to a satellite. In an embodiment, there may be an amplifier 312 and a filter 318 to amplify the transmitted signal. During the amplification of the signal, a filter 318 may be required to filter unwanted noise from the amplified signal. In an embodiment, amplifiers 312 and filters 318 may be used in combination to provide the desired signal strength and clarity. For example, amplifiers 312 and filters 318 may be alternated to step up the signal to the desired strength. In an embodiment, there may be a series of amplifiers 312 followed by a filter 318.

In the transmission amplification circuit, there may be a microprocessor 314 that may shut off and buffer data transmission for transmission at different times.

In the transmission amplification circuit, there may be a combination of a diode 322 and microprocessor 320 to monitor the signal strength of the transmitted signal. The transmitted signal strength may be modified to meet the requirements of a satellite.

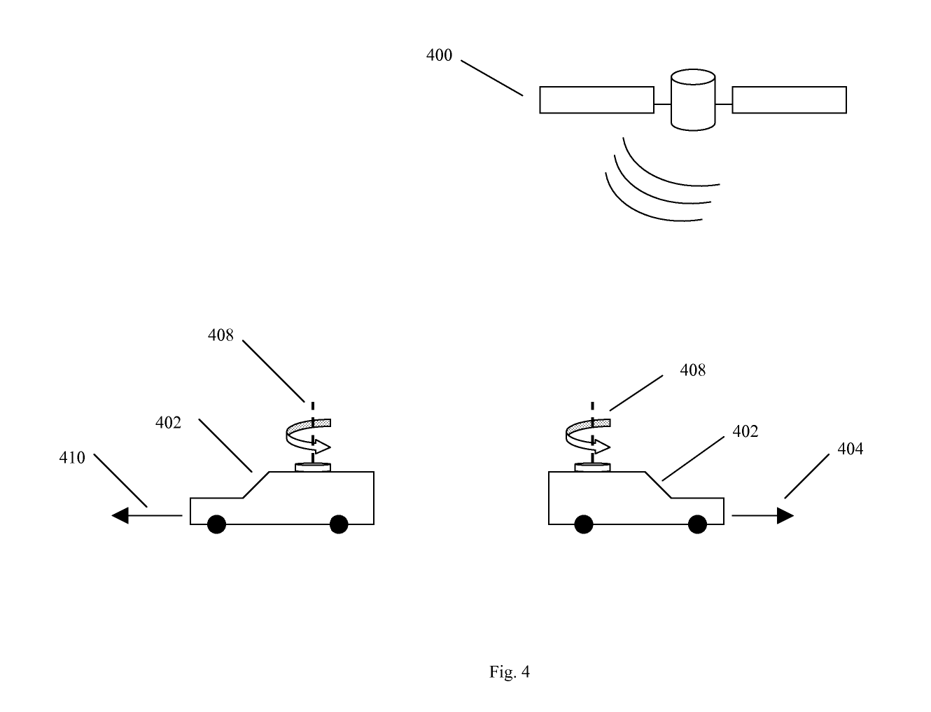

Referring to FIG. 4, an embodiment of the tracking of the co-planar parasitic patch antenna 408 to a satellite 400 signal is shown adjusting. The satellite 400 may be able to transmit and receive signals for the purpose of communication. A mobile platform 402 may be able to communicate with the satellite 400 by using the co-planar parasitic patch antenna 408. The antenna 408 may be able to orient the antenna 408 gain to provide optimum communication with the satellite 400. The antenna 408 may be rotated on a vertical axis to provide the optimum communication.

In an embodiment, with a mobile platform 402 moving in a first direction 404, the antenna 408 may maintain a certain orientation relative to the satellite 400. The orientation of the antenna 408 may be automatically optimized to maintain communications while moving in a direction 304. In an embodiment, the orientation of the antenna 408 may also be adjusted manually.

In an embodiment, the mobile platform 402 may vary its direction and move in a different direction 410. The modular patch antenna 408 may be automatically orientated by rotating on a vertical axis to provide an optimum communication to the satellite. In this manner, as the mobile platform moves and varies direction within a location, the antenna 408 may adjust to the new directions by rotating on the vertical axis to maintain an optimum communication.

In an embodiment, the antenna 408 may maintain the last orientation position during a signal obstruction. For example, the antenna may be receiving an adequate or maximized signal and then the signal may be interrupted by an obstruction of some sort. In this situation, the antenna may remain in the position it had when the signal was adequate or optimized. In embodiments, the antenna may change position looking for the signal for a period of time and then move back to the last position where the signal was adequate to wait for the obstruction to be removed. In embodiments, the antenna may stay in the original position where the signal was adequate or optimized for a period of time before moving to search for a better signal. The signal obstruction may be caused by a building, a mountain, a tunnel, or other object that interferes with a satellite signal for example. The signal may be reacquired after the signal obstruction is cleared. The antenna may or may not be rotated to reacquire the satellite signal.

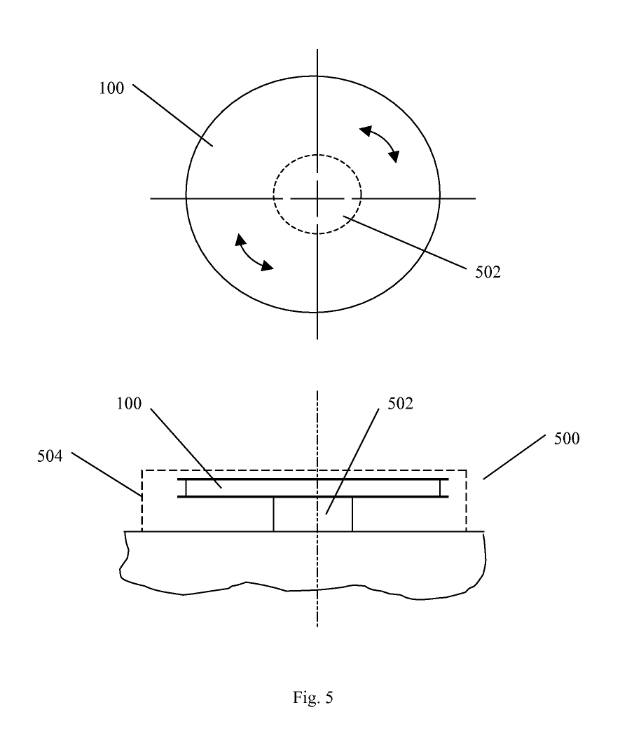

Referring to FIG. 5, an embodiment of a co-planar parasitic patch antenna assembly 500 is shown. In an embodiment, the antenna assembly 500 may maintain a low profile by using a co-planar parasitic patch antenna 100 that may be rotated horizontally on a vertical axis to maintain communication with a satellite. The horizontal co-planar parasitic patch antenna 100 may have a gain pattern, as described above, to communicate to a satellite at a certain elevation above the horizon without the need to orient the antenna 100 from horizontal. The horizontal positioning of the co-planar parasitic patch antenna 100 may permit a compact shape while maintaining communication to a satellite at a certain elevation. In embodiments, the horizontal positioning may be altered to maintain, optimize or otherwise change the reception of the co-planner parasitic patch antenna 100.

In an embodiment, the antenna 100 may be circular in shape, for example, and may rotate around a center axis. The antenna assembly 500 may be covered by a protective radome 504 with the antenna 100 rotating within the radome 504. In embodiments, the antenna 100 may be another appropriate shape.

The antenna 100 may be mounted on a rotary coupling 502 that may allow the rotational motion to maintain the optimum communication with a satellite 400. The rotary coupling 502 may provide the communication link from the receiver to the antenna 100 during rotation of the modular patch antenna 402 as described above.

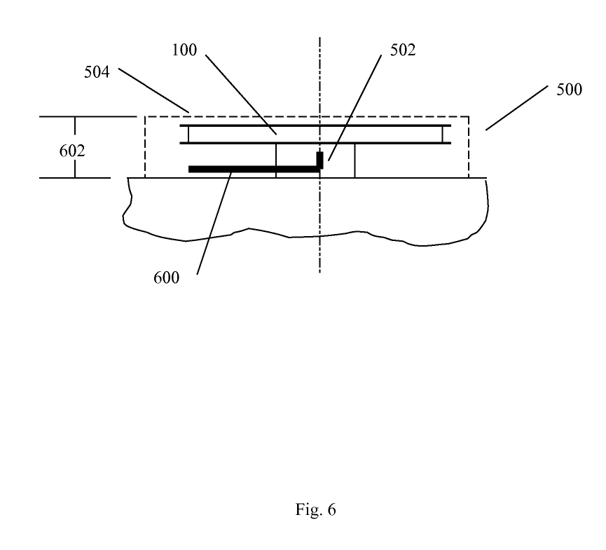

Referring to FIG. 6, an embodiment of a cable 600 connecting the co-planar parasitic patch antenna 402 to a receiver is shown. The antenna assembly 500 may be a low profile assembly by routing the connection cable 600 from under the antenna 100 to a rotary coupling 502. By connecting from below the antenna 100, through a rotary coupling 502, the assembly may be able to maintain a low profile height of approximately 2.5 inches 602. The low profile of the antenna assembly 500 may make the antenna more acceptable to users that mount the antenna to a mobile platform. The low profile antenna assembly 500 may be more esthetically acceptable to the user.

The antenna 100 rotating on a single vertical axis may also provide for a low profile design. The antenna 100 capabilities may provide communication to a satellite 400 without an additional axis of motion and may provide for a low profile assembly 500. By avoiding the need to move more than one axis, the antenna 100 may be contained in a small radome 504 and may provide for a compact height.

The rotary coupling 502 may provide a data connection between the antenna 100 and a receiver. The rotary coupling 502 may be one of several types to communicate data across the rotary joint, such as slip rings, brushes, optical, and induction couplings.

Slip ring and brush rotary couplings 502 are similar in that physical contact may be made between a stationary component and a rotating component of the rotary coupling 502 to transmit the data.

An optical rotary coupling 502 may use light wave technology to transmit data across a gap between the stationary and rotating component of the rotary coupling 502.

An induction rotary coupling 502 may use electromagnetic induction to transmit data across a gap between the stationary and rotating component of the rotary coupling 502.

Using a co-planar parasitic patch antenna 100 mounted horizontally and rotating on a single vertical axis, with a rotary coupling 502, to track an optimal satellite signal may provide a low profile antenna assembly of approximately 2.5 inches 602. The radome 504 may only be required to provide space for a single-axis co-planar parasitic patch antenna 100 to rotate to acquire a satellite signal. Using the co-planner parasitic patch antenna 100 may eliminate the need to access the satellite signal using more than one axis. By using just one rotary coupling 502 for one axis, the dB losses may be less than a multi-axis antenna using multiple rotary couplings and may provide for increased gain transmission to a receiver.

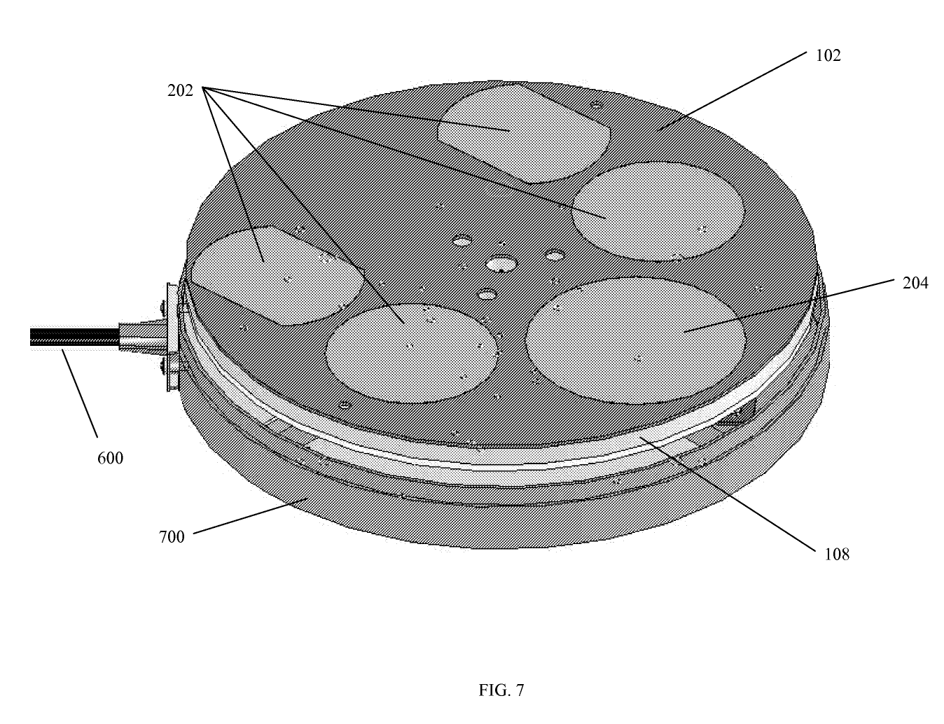

Referring to FIG. 7 an embodiment of the antenna assembly 500 mechanical components with the radome removed is shown. The co-planar parasitic patch antenna 100 may sit on top of the antenna components directly under the removed radome. As discussed in connection with FIG. 2, the co-planar parasitic patch antenna 100 may consist of the first substrate 108 and the second substrate 102. The second substrate 102 may have a parasitic patch that may modify the antenna gain pattern. The second substrate 102 may contain a director 204 patch and at least one reflector 202 patch. The co-planar parasitic patch antenna 100 may rotate around the vertical axis to maintain the satellite connection as the mobile platform 402 travels. The cable 600 may enter the antenna base 700 to be routed to the bottom of the co-planar parasitic patch antenna 100 as discussed in FIG. 6.

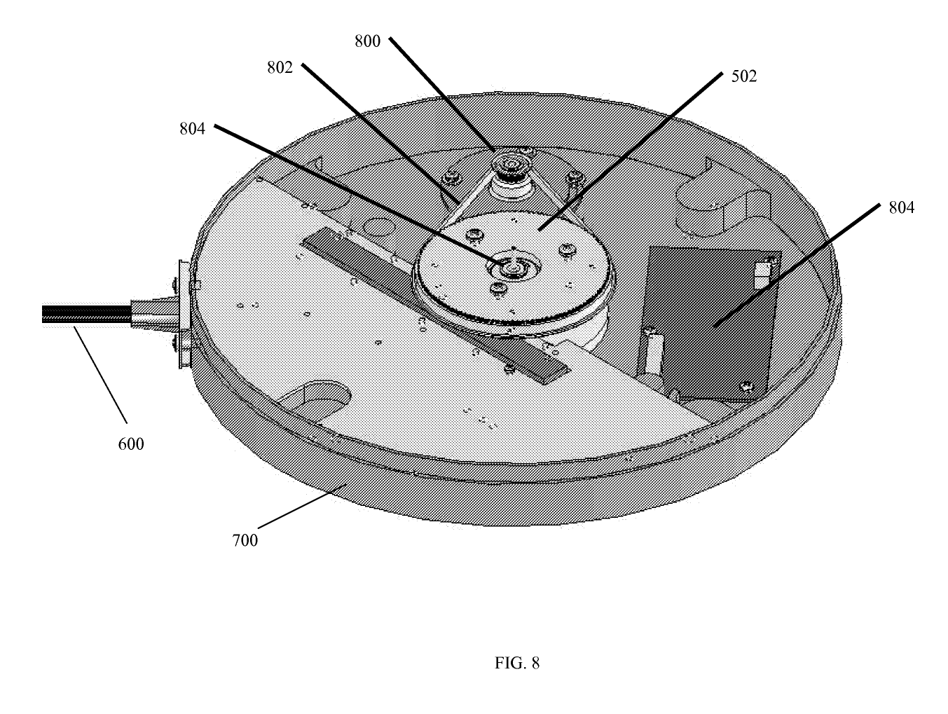

Referring to FIG. 8, an embodiment of the antenna assembly mechanical components with the radome and co-planar parasitic patch antenna 100 removed is shown. The antenna base 700 may contain all of the components of the co-planar parasitic patch antenna 100. The antenna base 700 may contain a mechanical or magnetic attachment facility to attach the antenna assembly 500 to the mobile platform 402. The cable 600 may enter at the side of the antenna base 700 and be routed and connected to the co-planar parasitic patch antenna 100 from under the co-planar parasitic patch antenna 100. The cable 600 may be routed to the rotary coupling 502, as discussed in connection with FIG. 5 the signal may be transmitted to the upper part of the rotary coupling to provide the electronic connection to the co-planar parasitic patch antenna 100 at location 804.

The rotary coupling 502 may support the co-planar parasitic patch antenna 100 by connecting to the first substrate 108. The rotary coupling 502 may rotate around the vertical axis maintaining the satellite signal connection as the mobile platform 402 travels. The rotary coupling 502 may be driven by a stepper motor 800 via a timing belt 802. The stepper motor 800 may receive signal information from a controller 804, the controller 804 signal may be contain at least information for the positioning of the co-planar parasitic patch antenna 100. The controller 804 signal may be transmitted to the stepper motor 800 where the controller 804 signal may be converted into rotational motion by the stepper motor 800. The stepper motor 800 rotational motion may be transferred to the co-planar parasitic patch antenna 100 via the timing belt 802.

All patents, patent applications, and other documents referred to herein are incorporated by reference. While the invention has been described in connection with certain preferred embodiments, other embodiments may be recognized by one of ordinary skill in the art and are encompassed herein, as limited only by the claims.

1. A method, comprising:
positioning a first substrate co-planar with respect to a second substrate;
providing at least one first parasitic patch in association with the first substrate, wherein the at least one first parasitic patch is adapted to provide antenna gain modification;
providing at least one second parasitic patch in association with the second substrate with, wherein the at least one second the parasitic patch is adapted to provide
antenna gain modification; and
orienting the co-planar parasitic patches of the first substrate and the second substrate for a substantially directional gain pattern.

2. The method of claim 1, further comprising:
orientating the antenna on a single axis to maintain optimal communication with a satellite.

3-14. (canceled)

15. The method of claim 1. wherein the parasitic patch is a driver.

16. The method of claim 1, wherein the parasitic patch is a director.

17. The method of claim 1, wherein the parasitic patch is a reflector.

18-22. (canceled)

23. The method of claim 1, wherein the antenna is adapted for use on a mobile platform.

24-30. (canceled)

31. The method of claim 23, wherein the antenna is adapted to track a signal during mobile platform movement thereby providing a tracking of the signal.

32. The method of claim 31, wherein the tracking includes rotating the antenna in order to maintain gain.

33. The method of claim 32, wherein the tracking involves maintaining satellite communication.

34. The method of claim 32, wherein the antenna automatically orients for optimum gain.

35. The method of claim 32, wherein the tracking involves manual orientation of the antenna.

36-37. (canceled)

38. The method of claim 1, wherein the antenna is adapted for satellite communications.

39. The method of claim 38, wherein the satellite communications include audio communication carried by a satellite signal.

40. (canceled)

41. The method of claim 38, wherein the satellite communications include data communication carried by a satellite signal.

42. The method of claim 38, wherein the satellite communications include telephonic communication carried by a satellite signal.

43-70. (canceled)

71. A system, comprising:
a first substrate co-planar with respect to a second substrate;
at least one first parasitic patch in association with the first substrate, wherein the at least one first parasitic patch is adapted to provide antenna gain modification; and
at least one second parasitic patch in association with the second substrate with, wherein the at least one second the parasitic patch is adapted to provide antenna gain modification; and wherein the co-planar parasitic patches are oriented on the first substrate and the second substrate for a substantially directional gain pattern.

72-129. (canceled)

130. A low profile antenna, comprising:
an antenna, wherein the antenna includes co-planar substrates with at least one parasitic patch;
wherein the antenna includes a cable access from under the antenna substrates; and
the antenna rotates on a single axis to maintain communication with a satellite, the axis being substantially vertical.

131. (canceled)

132. The system of claim 130, wherein the antenna is mounted horizontally.

133-134. (canceled)

135. The system of claim 132, wherein a coupling connects the antenna cable to the antenna.

136. The system of claim 135, wherein the coupling is a rotary coupling.

137-140. (canceled)
